(19) United States
(12) Patent Application Publication
(10) Pub. No.: US 2026/0214547 A1
(43) Pub. Date: Jul. 23, 2026

(54) DATA FORWARDING METHOD, APPARATUS AND DEVICE

(71) Applicant: SHANGHAI SATELLITE NETWORK RESEARCH INSTITUTE CO., LTD., Shanghai (CN)

(72) Inventors: Chengchen ZHANG, Shanghai (CN); Ping DU, Shanghai (CN); Xiaofan XU, Shanghai (CN); Shan LU, Shanghai (CN); Yiqun ZHAO, Shanghai (CN)

(73) Assignee: SHANGHAI SATELLITE NETWORK RESEARCH INSTITUTE CO., LTD., Shanghai (CN)

(21) Appl. No.: 19/570,417

(22) Filed: Mar. 18, 2026

Related U.S. Application Data
(63) Continuation of application No. PCT/CN2024/129493, filed on Nov. 1, 2024.

(30) Foreign Application Priority Data
May 13, 2024 (CN) 202410592708.4

(51) Int. Cl. H04W 40/24; H04W 28/06; H04W 84/06

(52) U.S. Cl. CPC H04W 40/246; H04W 28/06; H04W 84/06

(57) ABSTRACT

The present disclosure discloses a data forwarding method, apparatus and device. The method includes: a first control network element determining that data of a UE is for transmission via a designated ground station; determining reachability status between a store-and-forward network element and the designated ground station, the reachability status including communication reachability or communication unreachability; instructing the store-and-forward network element to perform transmission of the data of the UE via the designated ground station according to the reachability status. This solves the problem that the existing methods cannot meet the requirement of UE's data transmission via the designated ground station, and thus satisfies the corresponding transmission requirements.

### CROSS-REFERENCE TO RELATED APPLICATION

This application is a continuation of International Application No. PCT/CN2024/129493, filed on Nov. 1, 2024, which claims priority to Chinese Patent Application No. 202410592708.4, filed on May 13, 2024, both of which are hereby incorporated by reference in their entireties.

### TECHNICAL FIELD

The present disclosure relates to the technical field of satellite communication, in particular, to a data forwarding method, apparatus and device.

### BACKGROUND

The 3GPP (3rd Generation Partnership Project) is studying store and forward satellite operations. The store and forward satellite operations in 5G (Fifth-generation) systems with satellite access are designed to provide certain communication services, such as delay-tolerant communication services, for UE (User Equipment) under satellite coverage with intermittent/temporary satellite connections.

The store and forward (S&F) satellite operation mode contrasts with a normal/default satellite operation mode of the 5G system currently regarded as having satellite access as follows:

As shown in FIG. 1a, in the normal/default satellite operation mode, the signaling and data traffic exchange between the UE with satellite access and a remote ground network requires both a service link and a feed link to be active simultaneously. Therefore, when the UE interacts with the satellite via the service link, there exists a continuous end-to-end connection path among the UE, the satellite, and the ground network.

As shown in FIG. 1b, in the S&F satellite operation mode, the end-to-end exchange of the signaling and data traffic is handled as a combination of two non-simultaneous steps, labeled as steps A and B in FIG. 1b. In step A, the signaling/data exchange is carried out between the UE and the satellite, while the satellite is not simultaneously connected to the ground network, meaning that the satellite can operate the service link without an active feed link connection. In step B, a connection is established between the satellite and the ground network, enabling communication between the satellite and the ground network. Therefore, the satellite moves from being connected to the UE in step A to being connected to the ground network in step B.

According to the existing technology, the UE's data may be transmitted through any ground station. When the UE's data is required to be transmitted via a designated ground station, the existing technology cannot meet this requirement.

### SUMMARY

The purpose of the application is to provide a data forwarding method, apparatus and device, to solve the problem that the existing technology cannot meet the requirement that the UE's data can only be transmitted vial the designated ground station.

In a first aspect, an embodiment of the present disclosure provides a data forwarding method applied to a first control network element. The method includes:
determining that data of a UE is for transmission via a designated ground station;
determining reachability status between a store-and-forward network element and the designated ground station, where the reachability status includes communication reachability or communication unreachability;
instructing the store-and-forward network element to perform transmission of the data of the UE via the designated ground station according to the reachability status.

In some possible embodiments, the instructing the store-and-forward network element to perform transmission of the data of the UE via the designated ground station according to the reachability status includes:
when the reachability status is the communication unreachability, instructing the store-and-forward network element to store uplink data of the UE upon reception of the uplink data of the UE, and/or instructing the store-and-forward network element to discard downlink data of the UE upon reception of the downlink data of the UE transmitted by a non-designated ground station; or,
when the reachability status is the communication reachability, instructing the store-and-forward network element to forward uplink data of the UE to the designated ground station upon determination that the uplink data of the UE has been stored, and/or instructing the store-and-forward network element to store downlink data of the UE upon reception of the downlink data of the UE transmitted by the designated ground station.

In some possible embodiments, the determination that the data of the UE is for transmission via the designated ground station is based on at least one of following information:
subscription data information of the UE;
indication information provided by an AF or a second control network element;
local configuration information.

In some possible embodiments, the determination of the reachability status between the store-and-forward network element and the designated ground station is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

In some possible embodiments, further including:
receiving the reachability status notification information of the designated ground station based on a subscription or request for the reachability status notification information.

In some possible embodiments, the reachability status notification information includes at least one of the following:
indication information indicating a change in the reachability status;
predicted time information for a change in future reachability status;
information of the designated ground station.

In some possible embodiments, the data of the UE includes uplink data, and the uplink data includes all uplink data of the UE or a portion of session-level uplink data of the UE; and/or
the data of the UE includes downlink data, and the downlink data includes all downlink data of the UE or a portion of session-level downlink data of the UE.

In a second aspect, an embodiment of the present disclosure provides a data forwarding method applied to a second control network element. The method includes:
determining reachability status between a store-and-forward network element and a designated ground station via which data of a UE is to be transmitted, where the reachability status includes communication reachability or communication unreachability;
sending reachability status notification information to indicate the reachability status between the store-and-forward network element and the designated ground station.

In some possible embodiments, the method further includes:
determining that the data of the UE is for transmission via the designated ground station;
sending to a first control network element indication information that the data of the UE is for transmission via the designated ground station.

In some possible embodiments, the determination that the data of the UE is for transmission via the designated ground station is based on at least one of following information:
subscription data information of the UE;
local configuration information.

In some possible embodiments, the determination of the reachability status between the store-and-forward network element and the designated ground station via which the data of the UE is to be transmitted is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

In some possible embodiments, the sending reachability status notification information, includes:
sending the reachability status notification information according to a subscription or request for the reachability status notification information.

In some possible embodiments, the reachability status notification information includes at least one of the following:
indication information indicating a change in the reachability status;
predicted time information for a change in future reachability status;
information of the designated ground station.

In some possible embodiments, the data of the UE includes uplink data, and the uplink data includes all uplink data of the UE or a portion of session-level uplink data of the UE; and/or
the data of the UE includes downlink data, and the downlink data includes all downlink data of the UE or a portion of session-level downlink data of the UE.

In a third aspect, another embodiment of the present disclosure provides a data forwarding device which serves as a first control network element. The device includes at least one processor and a memory that communicates with the at least one processor. The memory stores an instruction executable by the at least one processor, and the instruction is executed by the at least one processor, so that the at least one processor can perform the data forwarding method provided in the first aspect.

In a fourth aspect, another embodiment of the present disclosure provides a data forwarding device which serves as a second control network element. The device includes at least one processor and a memory that communicates with the at least one processor. The memory stores an instruction executable by the at least one processor, and the instruction is executed by the at least one processor, so that the at least one processor can perform the data forwarding method provided in the second aspect.

In a fifth aspect, an embodiment of the present disclosure provides a data forwarding apparatus, where the apparatus serves as a first control network element and includes:
a designated ground station transmission determining module, configure to determine that data of a UE is for transmission via a designated ground station;
a communication reachability status determining module, configure to determine reachability status between a store-and-forward network element and the designated ground station, where the reachability status includes communication reachability or communication unreachability;
a data forwarding indicating module, configure to instruct the store-and-forward network element to perform transmission of the data of the UE via the designated ground station according to the reachability status.

In a sixth aspect, an embodiment of the present disclosure provides a data forwarding apparatus, where the apparatus serves as a second control network element and includes:
a reachability status determining module, configure to determine reachability status between a store-and-forward network element and a designated ground station via which data of a UE is to be transmitted, where the reachability status includes communication reachability or communication unreachability;
a reachability status indicating module, configure to send reachability status notification information to indicate the reachability status between the store-and-forward network element and the designated ground station.

In a seventh aspect, another embodiment of the present disclosure provides a computer storage medium, the computer-readable storage medium stores a computer program, where the computer program enables a computer to implement the data forwarding methods provided in any of the above aspects of the embodiments of the present disclosure.

According to the data forwarding method, apparatus and device provided in the embodiments of the present disclosure, the first control network element determines the reachability status and notifies the store-and-forward network element upon determining that the data of the UE is for transmission via the designated ground station, thereby guiding the store-and-forward network element to process the data of the UE, which can meet the requirement of the UE's data transmission via the designated ground station.

Other features and advantages of the present disclosure will be described in the subsequent specification, and partly become obvious from the specification or understood through implementations of the present disclosure. The purpose and other advantages of the present disclosure can be achieved and obtained through a structure specifically pointed out in the specification, claims and drawings written.

### BRIEF DESCRIPTION OF DRAWINGS

In order to illustrate the technical scheme of embodiments of the present disclosure more clearly, the drawings needed to be used in the embodiments of the present disclosure will be briefly introduced below. Obviously, the drawings in the following description are merely some embodiments of the present disclosure, and for those skilled in the art, other drawings can be obtained according to these drawings without paying creative effort.

FIG. 1a is a schematic diagram of communication under a normal/default satellite operation mode.

FIG. 1b is a schematic diagram of communication under a S&F satellite operation mode.

FIG. 2 is a schematic structural diagram of a non-roaming 5G communication system.

FIG. 3 is a schematic flowchart of a data forwarding method according to Embodiment of the present disclosure.

FIG. 4 is a schematic flowchart of a data forwarding method according to Embodiment 2 of the present disclosure.

FIG. 5 is a schematic flowchart of a data forwarding method according to Embodiment 3 of the present disclosure.

FIG. 6 is a schematic flowchart of data forwarding applied to a first control network element provided by an embodiment of the present disclosure.

FIG. 7 is a schematic flowchart of data forwarding applied to a second control network element provided by an embodiment of the present disclosure.

FIG. 8 is a schematic diagram of a data forwarding device serving as a first control network element provided by an embodiment of the present disclosure.

FIG. 9 is a schematic diagram of a data forwarding device serving as a second control network element provided by an embodiment of the present disclosure.

FIG. 10 is a schematic diagram of a data forwarding apparatus serving as a first control network element provided by an embodiment of the present disclosure.

FIG. 11 is a schematic diagram of a data forwarding apparatus serving as a second control network element provided by an embodiment of the present disclosure.

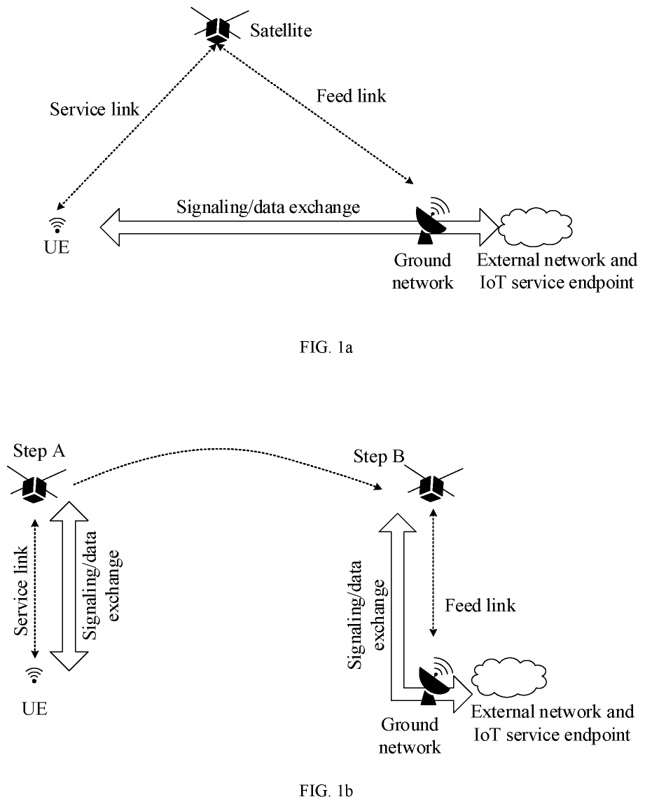

### DESCRIPTION OF EMBODIMENTS

To further illustrate the technical solution provided by embodiments of the present disclosure, a detailed description is given below in combination drawings and specific implementations. Although the embodiments of the present disclosure provide method operation steps as shown in the following embodiments or the drawings, more or fewer operation steps may be included in the method according to routine or non-creative labor. In steps where there is no necessary causal relationship logically, the execution sequence of these steps is not limited to the execution sequence provided by the embodiments of the present disclosure. During the actual processing or when executed by a control device, the method can be executed in sequence as shown in the embodiments or the drawings or in parallel.

The concept of storage and forwarding services is widely applied in the fields of a delay-tolerant network and an interrupt-tolerant network. For instance, in the 3GPP context, the service that can be assimilated into the S&F service is a short message service. For the short message service, no end-to-end connection between endpoints is required (for example, one endpoint can be a UE and the other endpoint can be an application server). A short message service center acts as an intermediary and is responsible for storing and forwarding short messages. Support for a satellite operation of the storage and forwarding service is particularly suitable for NGSO (Non-Geostationary Satellite Orbit) satellites providing delay-tolerant/non-real-time Internet of Things satellite services.

According to relevant technologies, UE's data may be transmitted via any ground station. When the UE's data is required to pass a designated ground station, the existing technology cannot meet this requirement. In view of the above technical problem, the present disclosure provides a data forwarding method, apparatus, device and a satellite, enabling the UE's data to be transmitted via a designated ground station.

Other features and advantages of the present disclosure will be described in the subsequent specification and become obvious partly from the specification, or be understood through the implementation of the present disclosure. The purpose and other advantages of the present disclosure can be achieved and obtained through structures specifically pointed out in the specification, claims and drawings written.

In the following, a detailed description of the data forwarding method, apparatus, device and a satellite in the embodiments of the present disclosure is provided in combination with the drawings.

In a communication system that utilizes satellite communication in related technologies, an architecture of the communication system where the UE's data may be transmitted via the designated ground station can, but is not limited to, be the 5G system architecture. In the communication system, a store-and-forward network element deployed on the satellite is responsible for the forwarding and storage of the UE's data. The store-and-forward network element can be a UPF (User Plane Function) or another network element. Meanwhile, the communication system also includes a first control network element and a second control network element for signaling interaction. The first control network element is configured to achieve control of storage and forwarding through signaling interaction and can be an SMF (Service Management Function), an AMF (Access and Mobility Management Function) or another network element. The second control network element conducts signaling interaction with the first control network element. For example, when the first control network element is an SMF, the second control network element is an AMF, based on this network architecture, an embodiment of the present disclosure provides a data forwarding system, including:

The first control network element determines that data of a UE is for transmission via a designated ground station; determines reachability status between a store-and-forward network element and the designated ground station, where the reachability status includes communication reachability or communication unreachability; instructs the store-and-forward network element to perform transmission of the data of the UE via the designated ground station according to the reachability status.

In the embodiments of the present disclosure, the designated ground station can be a gateway station or other ground nodes used for communication between UE and a DN (Data Network). The store-and-forward network element is deployed on the satellite. The reachability status between the store-and-forward network element and the designated ground station is equivalent to the reachability status between the satellite and the designated ground station. The reachability status between the store-and-forward network element and the designated ground station specifically refers to the reachability status of a feed link between the store-and-forward network element and the designated ground station.

The store-and-forward network element is configured to receive an instruction sent by the first control network element according to the reachability status between the store-and-forward network element and the designated ground station, and perform transmission of the UE's data via the designated ground station according to the instruction.

The first control network element in the present disclosure is a ground node or satellite. When it is determined that the UE's data is for transmission via the ground station, the store-and-forward network element is guided to store and forward the UE's data according to the reachability status between the store-and-forward network element and the designated ground station via which the UE's data is to be transmitted, so as to realize the transmission of the UE's data via the designated ground station and meet the requirements of UE's data transmission via the designated ground station.

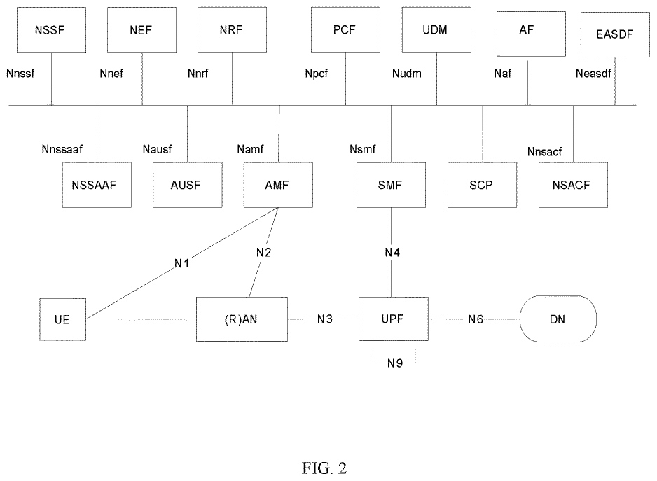

In the following, an architecture of a non-roaming 5G communication system shown in FIG. 2 is taken as an example to describe the names of network elements. However, the technical disclosure document is not limited to 5G, the architecture can also refer to future networks such as 6G and 7G, and the names of network elements can be replaced with the names of network elements in future networks. When the communication system adopts the 5G communication system, the first control network element can be an SMF, which is not limited in the present disclosure. Of course, it can also be an AMF, RAN (Radio Access Network). The store-and-forward network element can be a UPF, which is not limited in the present disclosure. Of course, it can also be an RAN, an AMF, an SMF, etc. The names and representations of messages, information, etc. in the embodiments of the present disclosure are only examples. They can be existing messages or information elements of other types, etc., or new types of messages or information elements in the future. An information element in a message of the embodiments of the present disclosure can be represented in the form of a message, and a message can be represented in the form of an information element within a message. In addition, the store-and-forward network element is not limited to being a network element on a satellite that directly receives data from a ground network element, it can also be a network element on a satellite that stores data which has finally arrived via transmission over an inter-satellite link.

The reachability status of the designated ground station relative to the store-and-forward network element refers to the status of a connection, whether it can be established or has already been established between the designated ground station and the store-and-forward network element, also known as data availability status. Communication reachability means that a connection can be established or has already been established between the designated ground station and the store-and-forward network element. Communication unreachability means that a connection fails to and cannot be established between the designated ground station and the store-and-forward network element, or a connection that has been established therebetween has been disconnected or is about to be disconnected.

The data of the UE is for transmission via the designated ground station. One possible scenario is that the data of the UE can only be transmitted via the designated ground station, i.e., the data of the UE cannot be transmitted via other ground stations except for the designated ground station. The data of the UE includes uplink data and/or downlink data. For uplink data, the data of the UE is for transmission via the designated ground station, which means that the uplink data sent by the UE to the data network (DN) on the ground via the store-and-forward network element can only be forwarded to the designated ground station through a satellite. For downlink data, the data of the UE is for transmission via the designated ground station, which means that the downlink data sent by the data network on the ground to the UE through the satellite can only be forwarded to the satellite via the designated ground station.

The first control network element instructs the store-and-forward network element to perform transmission of the data of the UE via the designated ground station according to the reachability status, including: when the reachability status is the communication unreachability, instructing the store-and-forward network element to store uplink data of the UE upon reception of the uplink data of the UE, and/or instructing the store-and-forward network element to discard downlink data of the UE upon reception of the downlink data of the UE transmitted by a non-designated ground station; or, when the reachability status is the communication reachability, instructing the store-and-forward network element to forward uplink data of the UE to the designated ground station upon determination that the uplink data of the UE has been stored, and/or instructing the store-and-forward network element to store downlink data of the UE upon reception of the downlink data of the UE transmitted by the designated ground station. The store-and-forward network element performs transmission of the data of the UE via the designated ground station according to the indication for data forwarding, including: according to the indication for data forwarding, when the reachability status is the communication unreachability, determining that a service link is reachable and a feed link is unreachable, and when receiving the uplink data of the UE, storing the uplink data of the UE and/or discarding the downlink data of the UE from the non-designated ground station; or, when the reachability status is the communication reachability, determining that the service link is unreachable and the feed link is reachable, and forwarding the uplink data of the UE to the designated ground station and/or storing the downlink data of the UE sent by the designated ground station, thereby meeting the requirement of the UE's data transmission via the designated ground station.

In the embodiments of the present disclosure, the first control network element determines that the data of the UE is for transmission via the designated ground station based on at least one of following information:

### 1) Subscription Data Information of the UE

The first control network element determines that the data of the UE is for transmission via the designated ground station according to the subscription data information of the UE.

The first control network element can obtain the subscription data information of the UE from a relevant network element. The subscription data information of the UE is specifically satellite forwarding subscription data information including information of the designated ground station. Exemplarily, the information of the designated ground station refers to identification information of one or more ground stations, or geographical location information of one or more ground stations, or an IP address of one or more ground stations.

### 2) Indication Information Provided by an AF or a Second Control Network Element

The AF can adopt an active trigger manner, but is not limited thereto, to send corresponding indication information when it is determined that the data of the UE is for transmission via the designated ground station. The indication information includes the information of the designated ground station, and the information of the designated ground station can include the corresponding content of the above-mentioned subscription data information. The first control network element determines that the data of the UE is for transmission via the designated ground station according to the indication information provided by the AF.

The second control network element determines that the data of the UE is for transmission via the designated ground station, and sends to the first control network element indication information that the data of the UE is for transmission via the designated ground station. The first control network element determines that the data of the UE is for transmission via the designated ground station according to the indication information sent by the second control network element.

The second control network element can be a network element that can conduct signaling interaction with the first control network element. The second control network element can determine that the data of the UE is for transmission via the designated ground station based on at least one of following information:

The subscription data information of the UE. Reference may be made to the above description for the specific content of the subscription data information.

Local configuration information. It is also possible to pre-configure, in the second control network element, the local configuration information that the data of the UE is for transmission via the designated ground station. The local configuration information is also known as satellite forwarding configuration information. In this way, the second control network element can determine that the data of the UE is for transmission via the designated ground station according to the relevant satellite forwarding configuration information.

It should be noted that, apart from the AF or the second control network element, another network element can also provide the above-mentioned indication information.

In the embodiment, the above-mentioned indication information may indicate information regarding the uplink data and/or regarding the downlink data for transmission via the designated ground station.

### 3) Local Configuration Information

The local configuration information that the data of the UE is for transmission via t designated ground station, also known as satellite forwarding configuration information, can be pre-configured in the first control network element. In this way, the first control network element can determine that the data of the UE is for transmission via the designated ground station according to the relevant satellite forwarding configuration information.

In the embodiments of the present disclosure, the first control network element determines the reachability status between the store-and-forward network element and the designated ground station based on at least one of following information:

### 1) Received Reachability Status Notification Information of the Designated Ground Station

The first control network element receives the reachability status notification information sent by the second control network element or another network element, and determines the reachability status between the store-and-forward network element and the designated ground station.

The reachability status notification information includes at least one of the following:
indication information indicating a change in the reachability status;
predicted time information for a change in future reachability status;
information of the designated ground station.

The above-mentioned another network element can be a radio access network (RAN). The first control network element receives the reachability status notification information sent by the designated ground station, and determines, based on the reachability status notification information, the reachability status between the store-and-forward network element and the designated ground station via which the data of the UE is to be transmitted. The first control network element can send a ground station reachability status request message to the RAN, and determines the reachability status between the store-and-forward network element and the designated ground station via which the data of the UE is to be transmitted based on the reachability status notification information sent by the RAN in response to the ground station reachability status request message.

2) At least one of local ephemeris data, information of a satellite hosting the store-and-forward network element, information of the designated ground station, or connection status between the store-and-forward network element and the designated ground station.

The first control network element determines the reachability status between the store-and-forward network element and the designated ground station according to at least one of the ephemeris data, the information of the satellite hosting the store-and-forward network element, the information of the designated ground station, or the connection status between the store-and-forward network element and the designated ground station. Specifically, a location and a coverage footprint of the satellite hosing the store-and-forward network element can be determined according to the ephemeris data and the information of the satellite hosting the store-and-forward network element. According to the information related to the designated ground station, it can be determined whether the designated ground station is within the coverage footprint of the satellite hosing the store-and-forward network element. The above-mentioned connection status between the satellite and the designated ground station includes connected status or disconnected status, it can assist in determining the reachability status between the store-and-forward network element and the designated ground station.

When determining the reachability status with the designated ground station based on the information in the above item 1), if the reachability status notification information is received from the second control network element, the second control network element determines the reachability status between the store-and-forward network element and the designated ground station via which the data of the UE is to be transmitted based on at least one of following information:

### 1.1) Received Reachability Status Notification Information of the Designated Ground Station

The second control network element receives the reachability status notification information sent by the radio access network (RAN), and determines the reachability status between the store-and-forward network element and the designated ground station via which the data of the UE is to be transmitted based on the reachability status notification information.

The second control network element can send a ground station reachability status request message to the radio access network (RAN), and determines the reachability status between the store-and-forward network element and the designated ground station via which the data of the UE is to be transmitted based on the reachability status notification information sent by the RAN in response to the ground station reachability status request message.

In one implementation, the second control network element can send the ground station reachability status request message to the RAN according to a request from the first control network element, or send the ground station reachability status request message to the RAN after determining that the data of the UE can only be transmitted via the designated ground station. The ground station reachability status request message includes information of the designated ground station. The ground station reachability status request message can also indicate a trigger manner for reporting the reachability status of the ground station. For example, the ground station reachability status request message instructs the RAN to perform periodic reporting and provides a reporting cycle, or it instructs the RAN to report when the reachability status of the designated ground station changes (such as from reachability to unreachability, or from unreachability to reachability), and so on.

1.2) At least one of local ephemeris data, information of a satellite hosting the store-and-forward network element, information of the designated ground station, or connection status between the store-and-forward network element and the designated ground station.

The second control network element determines the reachability status between the store-and-forward network element and the designated ground station according to at least one of the ephemeris data, the information of the satellite hosting the store-and-forward network element, the information of the designated ground station, or the connection status between the store-and-forward network element and the designated ground station, and sends reachability status notification information to indicate the reachability status between the store-and-forward network element and the designated ground station. The specific implementation is the same as the implementation in which the first control network element itself determines the reachability status between the store-and-forward network element and the designated ground station. This will not be repeated here.

When determining the reachability status according to the above item 1.2), the second control network element sends the reachability status notification information to the first control network element, including: sending the reachability status notification information according to a subscription or request for the reachability status notification information. The first control network element receives the reachability status notification information sent by the second control network element, including: receiving the reachability status notification information of the designated ground station according to the subscription or request for the reachability status notification information. The second control network element establishes a subscription relationship with the first control network element to send the reachability status notification information when the reachability status changes, and sends, according to the subscription relationship, the reachability status notification information to the first control network element when the reachability status changes.

The establishment of the subscription relationship between the first control network element and the second control network element enables the second control network element to send the reachability status notification information when the reachability status changes according to the reachability status between the store-and-forward network element and the designated ground station.

The second control network element can adopt any of the following methods to establish the subscription relationship for sending the reachability status notification information when the reachability status changes:

Establishment of an explicit subscription relationship: If the first control network element does not determine the reachability status between the store-and-forward network element and the designated ground station, the first control network element sends a reachability status change subscription request message to the second control network element, and establishes the explicit subscription relationship with the second control network element for the reachability status notification information to be sent when the reachability status changes. The second control network element receives the reachability status change subscription request message sent by the first control network element and establishes the explicit subscription relationship with the first control network element to send the reachability status notification information when the reachability status changes. This method can be applied in a scenario where the first control network element determines that the data of the UE is for transmission via the designated ground station, but is not limited thereto.

Establishment of an implicit subscription relationship: The first control network element receives the indication information which is sent by the second control network element and indicates that the data of the UE is for transmission via the designated ground station, and establishes the implicit subscription relationship with the second control network element for the reachability status notification information to be sent when the reachability status changes. Alternatively, upon reception of the above-mentioned indication information sent by the second control network element and as a response, the first control network element establishes the implicit subscription relationship with the second control network element for the reachability status notification information to be sent when the reachability status changes. The second control network element establishes the implicit subscription relationship with the first control network element to send the reachability status notification information when the reachability status changes, by sending the above indication information to the first control network element. The second control network element receives from the first control network element the response to the indication information, and establishes the implicit subscription relationship with the first control network element to send the reachability status notification information when the reachability status changes. This method can be applied in a scenario where the second control network element determines that the data of the UE is for transmission via the designated ground station and sends designated ground station forwarding information, but is not limited thereto.

In the embodiments of the present disclosure, the second control network element may adopt any of the following implementations to notify the first control network element by means of the reachability status notification information:

The second control network element determines a satellite mobility event where the reachability status changes and sends reachability status notification information to the first control network element. The first control network element receives the reachability status notification information sent by the second control network element, and determines the reachability status between the store-and-forward network element and the designated ground station according to the occurred satellite mobility event where the reachability status changes.

A satellite mobility event refers to an event where the reachability status of the designated ground station relative to the satellite changes as the satellite moves.

In one implementation, when the designated ground station relative to the satellite changes from unreachable to reachable, or when the designated ground station relative to the satellite changes from reachable to unreachable, the second control network element needs to send the reachability status notification information to the first control network element.

For example, the designated ground stations include a ground station 1 and a ground station 2. When the coverage footprint of the satellite includes the ground station 1, the second control network element notifies the first control network element. When the coverage footprint of the satellite does not include the ground station 1 and the ground station 2, the second control network element notifies the first control network element. When the coverage footprint of the satellite includes the ground station 2, the second control network element notifies the first control network element. Alternatively, the designated ground station includes the ground station 1 and the ground station 2. When the coverage footprint of the satellite includes the ground station 1 and the satellite can establish a connection with the ground station 1 or has established a connection with the ground station 1 for data transmission, the second control network element notifies the first control network element. When the coverage footprint of the satellite does not include the ground station 1 or the satellite cannot establish a connection with the ground station 1 or has disconnected a connection established with the ground station 1, the second control network element notifies the first control network element. When the coverage footprint of the satellite includes the ground station 2 and the satellite can establish a connection with the ground station 2 or has established a connection with the ground station 2 for data transmission, the second control network element notifies the first control network element.

In some possible embodiments, the second control network element may provide the first control network element with time information of the satellite mobility event when notifying the first control network element. The time information of the satellite mobility event includes information on the time when the satellite mobility event occurred. In the embodiments of the present disclosure, the second control network element may notify the first control network element at a preset time before or after the occurrence of the satellite mobility event.

For example, when the coverage footprint of the satellite starts to include a location of the designated ground station, the second control network element determines that a connection can be established between the designated ground station and the store-and-forward network element, i.e., the satellite mobility event occurs. However, due to an excessively small elevation angle, even if the connection is established, it may be unstable. Therefore, when sending the reachability status notification information to the first control network element, the second control network element includes the time information of the satellite mobility event in the reachability status notification information. The first control network element can determine, based on the time information of the satellite mobility event, the time configuration for the store-and-forward network element, i.e., when to send a message to the store-and-forward network element to request data reception, data forwarding, etc. In this scenario, the second control network element can also notify the first control network element after the preset time elapses since the coverage footprint of the satellite includes the designated ground station. When the coverage footprint of the satellite is about to exclude the location of the designated ground station, the connection between the designated ground station and the store-and-forward network element may become unstable and even disconnect at any time despite its existence, due to an excessively small elevation angle. Therefore, in this scenario, the second control network element sends the reachability status notification information to the first control network element in advance, and includes the time information of satellite mobility event in the reachability status notification information. Similarly, the first control network element can determine, based on the time information of the satellite mobility event, the time configuration for the store-and-forward network element, i.e., when to send a request message to the store-and-forward network element to request data storage, data discarding, etc. In this implementation, the reachability status notification information sent by the second control network element to the first control network element notifies the satellite mobility event that the designated ground station is reachable, then the first control network element requests the store-and-forward network element to forward the downlink data of the UE to the designated ground station.

In the embodiments of the present disclosure, there is at least one designated ground station. When there is one designated ground station, the reachability status notification information does not need to carry an identifier of a designated ground station. When there are multiple designated ground stations, the identifier of the designated ground station whose reachability status changes needs to be carried.

In a first implementation of the present embodiment, if there is only one designated ground station, the reachability status notification information only carries the indication information of the satellite mobility event indicating a change in the reachability status, or, if there is only one designated ground station, the reachability status notification information only carries the indication information of the satellite mobility event indicating a change in the reachability status and occurrence time. Specifically, when the first control network element receives the indication information that the data of the UE is for transmission via the designated ground station but does not receive the reachability status notification information, or when the first control network element receives the reachability status notification information but the satellite mobility event indicates unreachability, the first control network element determines that the uplink data of the UE to be sent to the designated ground station needs to be stored on the store-and-forward network element. Moreover, the store-and-forward network element cannot receive the downlink data of the UE from the designated ground station. Therefore, the first control network element needs to store the uplink data of the UE in the store-and-forward network element deployed on the satellite, and may also request the store-and-forward network element to discard the downlink data of the UE. If the reachability status notification information carries the occurrence time, then the first control network element can determine the time configuration for the store-and-forward network element according to the occurrence time. In this implementation, assuming that the store-and-forward network element can determine information of the designated ground station from which the received data comes and also can determine information of the designated ground station to which the data is sent.

In a second implementation of the present embodiment, there are multiple designated ground stations. The reachability status notification information carries the indication information of the satellite mobility event indicating a change in the reachability status and an identifier of a corresponding designated ground station, or carries the indication information of the satellite mobility event indicating a change in the reachability status, the identifier of the corresponding designated ground station and the occurrence time. If the first control network element receives the indication information that the data of the UE is for transmission via the designated ground station but does not receive the reachability status notification information, or receives the reachability status notification information but the satellite mobility event indicates that the designated ground station is unreachable, then the first control network element determines that the uplink data of the UE to be sent to the corresponding designated ground station needs to be stored on the store-and-forward network element. Moreover, the store-and-forward network element is unable to receive the downlink data of the UE from the corresponding designated ground station. Therefore, the first control network element needs to store the uplink data of the UE in the store-and-forward network element deployed on the satellite, and can also request the store-and-forward network element to discard the downlink data of the UE. Unlike the first implementation mentioned above, an identifier of a designated ground station is included. Then, the first control network element requests the store-and-forward network element to store the uplink data of the UE, including: requesting the store-and-forward network element to store the uplink data of the UE until the store-and-forward network element can send data to the ground station corresponding to said identifier of the designated station. The first control network element requests the store-and-forward network element to discard the downlink data of the UE, including: requesting the store-and-forward network element to discard the received downlink data of the UE until the received downlink data of the UE comes from the ground station corresponding to said identifier of the designated ground station.

In another possible implementation, namely a third implementation, the second control network element determines the satellite mobility event where the reachability status changes at a future time and its occurrence time in the future, and sends the reachability status notification information to the first control network element. The first control network element receives the reachability status notification information sent by the second control network element, and determines the reachability status between the store-and-forward network element and the designated ground station, according to the satellite mobility event where the reachability status changes in the future and its occurrence time in the future.

In the first and second implementations mentioned above, the time information of the satellite mobility event contained in the reachability status notification information is time information pertaining to a satellite mobility event occurring immediately before the sending of said reachability status notification information, whereas the time information of the satellite mobility event herein can include the time information of multiple future satellite mobility events. In the embodiments of the present disclosure, there is at least one designated ground station. When there is only one designated ground station, the reachability status notification information may not carry an identifier of a designated ground station, and when there are multiple designated ground stations, the reachability status notification information shall carry the identifier of the designated ground station whose reachability status has changed.

During implementation, when there is only one designated ground station, the reachability status notification information only carries the indication information of the satellite mobility event where the reachability status changes in the future and its occurrence time in the future. When there are multiple designated ground stations, the reachability status notification information carries the indication information of the satellite mobility event where the reachability status changes in the future and its occurrence time in the future, and an identifier of the corresponding designated ground station.

For example, the designated ground stations include a ground station 1 and a ground station 2. The time information of the satellite mobility event includes the time information of the ground station 1 being reachable, the ground station 1 being unreachable, the ground station 2 being reachable, and the ground station 2 being unreachable, etc. If the time information of the satellite mobility event includes the identifier of the designated ground station, then the reachability status notification information includes mapping information of the time and the identifier of the designated ground station. If the time information of the satellite mobility event does not contain the identifier of the designated ground station, the reachability status notification information only includes the satellite mobility event and its occurrence time in the future. For example, a designated ground station is reachable at a certain time point, and no designated ground station is reachable at a certain time point.

When the first control network element receives the designated ground station forwarding information but does not receive the reachability status notification information, or receives the reachability status notification information but the satellite mobility event indicates that the designated ground station is unreachable, then the first control network element determines that the uplink data of the UE to be sent to the corresponding designated ground station needs to be stored on the store-and-forward network element. Moreover, the store-and-forward network element is unable to receive the downlink data of the UE from the corresponding designated ground station. Therefore, the first control network element needs to store the uplink data of the UE in the store-and-forward network element deployed on the satellite, and can also request the store-and-forward network element to discard the downlink data of the UE. The first control network element determines that the designated ground station is unreachable at a specific future time according to the satellite mobility event and its occurrence time in the future included in the reachability status notification information. Then, the first control network element requests the store-and-forward network to store the uplink data of the UE, including: requesting the store-and-forward network element to store the uplink data of the UE until the store-and-forward network element determines that the designated ground station is reachable at the occurrence time in the future according to the time information of the satellite mobility event. The first control network element requests the store-and-forward network element to discard the downlink data of the UE, including: requesting the store-and-forward network element to discard the received downlink data of the UE until the store-and-forward network element determines that the above-mentioned designated ground station is reachable at the occurrence time in the future according to the time information of the satellite mobility event.

The data of the UE in the embodiments of the present disclosure is either UE-level data or session-level data.

In the following, an example is taken where the first control network element is an S and the store-and-forward network element is a UPF, to present data forwarding processes in a data forwarding system provided by the embodiments of the present disclosure.

### Embodiment 1

The scenario of this embodiment is that the entire data of the UE is for transmission via a designated ground station.

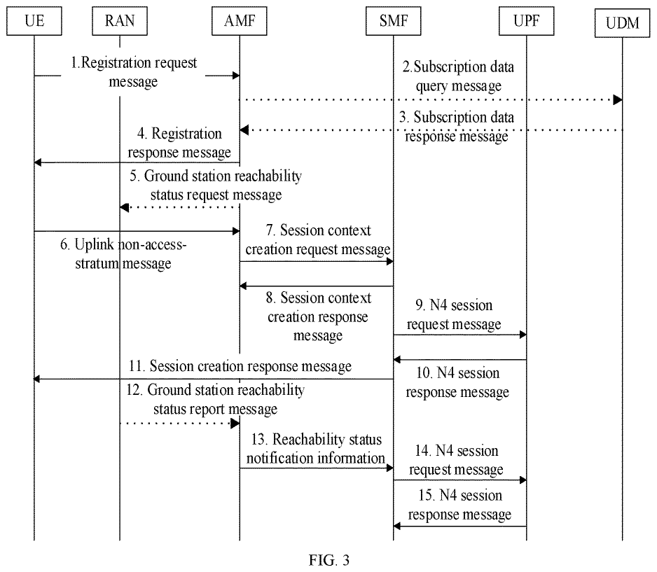

The AMF queries subscription data information or local configuration information indicating that the UE's data is for transmission via the designated ground station, and instructs the SMF via indication information. When the designated ground station is unreachable, the SMF instructs the UPF to store uplink data of the UE, and discard downlink data when receiving the downlink data of the UE from another ground station. When the designated ground station is reachable, the SMF instructs the UPF to forward the uplink data and store the downlink data. The SMF can implicitly subscribe to notifications of reachability status changes from the AMF, or determine the reachability status of the designated ground station according to the information provided by the AMF. As shown in FIG. 3, it mainly includes the following steps:
Step 1, the UE sends a registration request message to the AMF.
Step 2, the AMF sends a subscription data query message to a UDM.
Step 3, the UDM sends a subscription data response message to the AMF. The message includes the subscription data information of the UE, and the subscription data information of the UE indicates that the data of the UE is for transmission via a designated ground station.

The subscription data information of the UE is satellite forwarding subscription data information. If the satellite forwarding subscription data information already exists in the AMF, or if the AMF has been configured with satellite forwarding configuration information that includes the content of the satellite forwarding subscription data information, then Step 3 does not contain the satellite forwarding subscription data information, or Steps 2 and 3 will not be executed.
Step 4, the AMF sends a registration response message to the UE.
Step 5, in an implementation, the AMF sends a ground station reachability status request message to an RAN. The message requests the RAN to report the reachability status of the designated ground station to the AMF. There is no limitation on which step the message is involved in. For example, it might be sent during the process of sending the registration response message in Step 4, or after Step 6.
Step 6, the UE sends an uplink non-access-stratum (UL NAS) message to the AMF. The message includes a session establishment request message sent by the UE to the SMF.
Step 7, the AMF sends a session context creation request message to the SMF. The message includes indication information indicating that the data of the UE can only be transmitted via the designated ground station.

Specifically, the AMF determines that the data of the UE can only be transmitted via the designated ground station according to the subscription data information of the UE or the local configuration information, and sends designated ground station forwarding information to the SMF after receiving the UL NAS message containing the session establishment request message sent by the UE to the SMF.

In an implementation, the SMF implicitly subscribes the UE's reachability event from the AMF, namely a satellite mobility event. The AMF will notify the SMF when the reachability status changes.

When the reachability status changes, the AMF will notify the SMF via the reachability status notification information. Specifically, any one of the above three implementations can be adopted, which will not be repeated here.

It should be noted that if Step 5 has been carried out beforehand, the AMF does not need to re-determine the reachability status by itself, but directly determines it according to the reachability status provided by the RAN.

If the SMF does not receive a notification of the satellite mobility event that the designated ground station is reachable, the designated ground station will be deemed unreachable by default.
Step 8, the SMF sends a session context creation response message to the AMF, where the message is used to respond to the session context creation request message.
Step 9, the SMF sends a N4 session request message to the UPF when the reachability status is unreachable. This message requests the UPF to store uplink data of the UE and requests the UPF to discard downlink data from ground station(s) other than the designated ground station. For specific details, please refer to the description of the above implementations, which will not be repeated here.
Step 10, the UPF sends a N4 session response message to the SMF, where the message is used to respond to the N4 session request message.
Step 11, the SMF sends a session creation response message to the UE, where the message is used to respond to a session creation request message.
Step 12, in an implementation, the RAN sends a ground station reachability status report message to the AMF, where the message indicates that the designated ground station is reachable.

In this embodiment, the ground station reachability status report message is sent when the specified trigger mode is met, that is, it may not be sent immediately after receiving the ground station reachability status report message.
Step 13, the AMF sends a reachability status notification information to the SMF.

If Steps 5 and 12 have been carried out, the AMF determines the satellite mobility event based on the ground station reachability status report message provided by the RAN.
Step 14, the SMF sends a N4 session request message to the UPF when determining that the designated ground station is reachable according to the reachability status notification information, where the message requests the UPF to forward the uplink data of the UE to the designated ground station and requests the UPF to store the downlink data of the UE received from the designated ground station.

The SMF may determine whether the designated ground station is reachable or unreachable according to the reachability status notification information from the AMF, or it can determine whether the designated ground station is reachable or unreachable through other means such as by itself.

For the three implementations of the reachability status notification information, SMF has corresponding implementations for the indication to the UPF. For specific details, please refer to the above implementation descriptions.

If the message in Step 9 includes an identifier of the designated ground station, Step 14 will not be executed.

If the message in Step 9 includes time information of the satellite mobility event, Step 14 will not be executed.
Step 15, the UPF sends a N4 session response message to the SMF, where the message serves as a response to the N4 session request message.

### Embodiment 2

The scenario of this embodiment is that some session data of the UE is for transmission via a designated ground station.

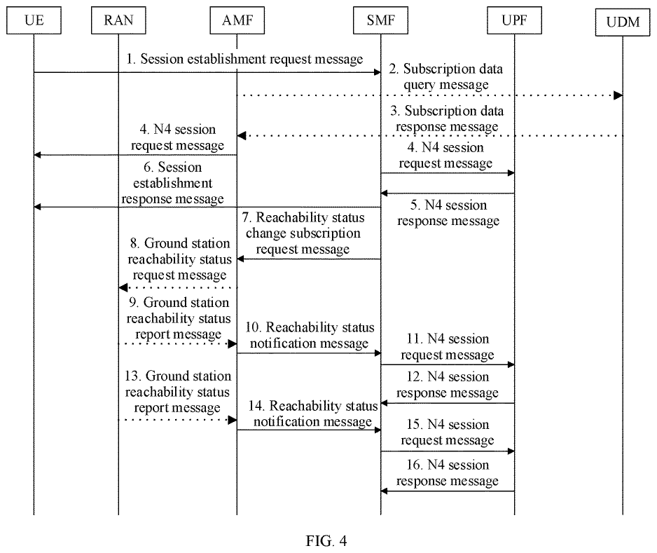

The SMF queries subscription data information of the UE or local configuration information indicating that some session data of the UE can only be transmitted via the designated ground station. When determining that the designated ground station is unreachable, the SMF instructs the UPF to store uplink data of the UE, and discard downlink data when receiving the downlink data of the UE from another ground station. When the designated ground station is reachable, the SMF instructs the UPF to forward the uplink data and store the downlink data from the designated ground station. The SMF can explicitly subscribe the reachability status of the designated ground station from the AMF or, it can determine the reachability status of the designated ground station by itself. As shown in FIG. 4, it mainly includes the following steps:
Step 1, the UE sends a session establishment request message to the SMF.

At the same time as receiving the session establishment request message, the SMF will also receive a DNN (Data Network Name) and/or S-NSSAI (Single Network Slice Selection Assistance Information) associated with this session from the UE.
Step 2, the SMF sends a subscription data query message to a UDM.
Step 3, the UDM sends a subscription data response message to the SMF. The message includes the subscription data information of the UE, and the subscription data information of the UE indicates that data of the UE's session associated with the DNN and/or S-NSSAI can only be transmitted via the designated ground station. That is, except for the designated ground station, the data of the UE's session associated with the DNN and/or S-NSSAI cannot be transmitted through other ground station(s).

The subscription data information of the UE includes information of the designated ground station, as detailed in Step 3 of Embodiment 1. In addition, it also includes the DNN and/or S-NSSAI. For example, the data of the session associated with a DNN 1 can only be transmitted via a ground station 1 and a ground station 2, the data of the session associated with S-NSSAI 1 can only be transmitted via a ground station 3, the data of the session associated with DNN 2 and S-NSSAI 2 can only be transmitted via the ground station 2, and the data of the session associated with DNN 2 and S-NSSAI 3 can only be transmitted via the ground station 2 and the ground station 3.

If the subscription data information of the UE already exists in the SMF, or if the SMF has been configured with satellite forwarding configuration information that includes the content of the subscription data information of the UE, then Step 3 does not contain the subscription data information of the UE, or Steps 2 and 3 will not be executed.
Step 4, the SMF sends a N4 session request message to the UPF. The message can request the UPF to store the uplink data sent by the UE to the designated ground station, and the message can also request the UPF to discard the downlink data from ground station(s) other than the designated ground station.

Specifically, when the SMF receives the session establishment request message and the DNN and/or S-NSSAI associated with the session, and determines, according to the subscription data information of the UE or the local configuration information, that the session data can only be transmitted via the designated ground station and the designated ground station is unreachable, the SMF then requests the UPF to store the uplink data sent by the UE to the designated ground station and it can also request the UPF to discard the downlink data of the UE from other non-designated ground station(s). The SMF determines whether the designated ground station is reachable in accordance with factors that the AMF needs to consider. If the SMF is unable to determine the reachability status of a ground station, the SMF will not request the UPF to store or discard data via the message in Step 4.
Step 5, the UPF sends a N4 session response message to the SMF, where the message serve as a response to the N4 session request message.
Step 6, the SMF sends a session establishment response message to the UE, where the message serves as a response to the session establishment request message.
Step 7, the SMF sends a reachability status change subscription request message to the AMF, where the message requests a subscription to a satellite mobility event and includes information of the designated ground station.

The sequence for executing Step 7 is not limited. For example, Step 7 can be executed after Step 5, or before Step 4. Exemplarily, if the SMF determines that the data of a specific session can only be transmitted via the designated ground station and the SMF cannot determine the reachability status of the designated ground station by itself, then Step 7 is executed before Step 4. In this case, the AMF needs to respond to the SMF promptly after receiving the reachability status change subscription request message, that is, to execute Steps 8-10.

Specifically, if the SMF is unable to determine the reachability status of the designated ground station, it will send the reachability status change subscription request message to the AMF. If the SMF can determine the reachability status of the designated ground station, Steps 7-12 will not be executed.
Step 8, in an implementation, the AMF sends a ground station reachability status request message to an RAN. The message requests the RAN to report the reachability status of the designated ground station to the AMF. Specifically, it is the same as Step 5 of Embodiment 1.
Step 9, in an implementation, the RAN sends a ground station reachability status report message to the AMF, where the message indicates that the designated ground station is unreachable.
Step 10, the AMF sends a reachability status notification message to the SMF, where the message informs that the designated ground station is unreachable.
Step 11, the SMF sends a N4 session request message to the UPF. The message can request the UPF to store the uplink data sent by the UE to the designated ground station, and the message can also request the UPF to discard the downlink data from ground station(s) other than the designated ground station.

Specifically, the SMF receives the session establishment request message and the DNN and/or S-NSSAI associated with the session, and determines, according to the subscription data information of the UE or the local configuration information, that the data of the session can only be transmitted via the designated ground station and the designated ground station is unreachable, the SMF then requests the UPF to store the uplink data of the UE, and it can also request the UPF to discard the downlink data of the UE. The SMF determines that the designated ground station is unreachable according to the notification received in Step 10, or the SMF does not receive the notification from the AMF, it thus determines that the designated ground station is unreachable. In the latter implementation, Step 10 will not be executed.
Step 12, the UPF sends a N4 session response message to the SMF, where the message serves as a response to the N4 session request message.
Step 13, in an implementation, the RAN sends a ground station reachability status report message to the AMF, where the message indicates that the designated ground station is reachable.
Step 14, the AMF sends a reachability status notification message to the SMF, where the message informs that the designated ground station is reachable.
Step 15, the SMF sends a N4 session request message to the UPF, where the message requests the UPF to forward the uplink data. Specifically, it is the same as Step 12 of Embodiment 1.
Step 16, The UPF sends a N4 session response message to the SMF, where the message serves as a response to the N4 session request message.

### Embodiment 3

The scenario of this embodiment is that the requirement for data transmission via a designated ground station is triggered by an AF.

The AF sends a request message to a PCF to govern traffic routing. The request message includes information of the designated ground station, indicating that UE's data can only be transmitted via the designated ground station. The PCF determines a policy rule and provides the SMF with a rule including the information of the designated ground station. When reachability status of the designated ground station changes, the SMF modifies the configuration of the UPF. As shown in FIG. 5, it mainly includes the following steps:
Step 1, the UE sends a session establishment request message to the SMF.
Step 2, the SMF sends a session establishment response message to the UE.
Step 3, an AF/NEF (Network Exposure Function) sends a policy authorization request message to the PCF, where the message includes information of the designated ground station.

The AF may send information directly to the PCF or send information through the NEF. Sending the information through the NEF means that the AF first sends a message to the NEF, and then the NEF sends the message to the PCF.

The message can include an address of the UE to specify that the information sent by the AF is used to govern traffic routing of a specific session.

The message can also include other UE-related identification information to indicate a target of the request, such as an identifier of a UE, a list of UE identifiers, a group of UEs represented by an internal group identifier, or any UE that accesses a combination of an access DNN, an S-NSSAI and a DNAI (DN Access Identifier).

The message can also indicate that the data of the UE can be transmitted via the designated ground station, or include information of the designated ground station to implicitly indicate that the data of the UE can be transmitted via the designated ground station.
Step 4, the PCF sends a policy control request message to the SMF, where the message includes the information of the designated ground station. Specifically, the policy control request message can include policy rule information, and the policy rule information includes the information of the designated ground station.
Step 5, the SMF sends a policy control response message to the PCF, where the message is used to respond to the policy control request message.

If the SMF can determine whether the designated ground station is reachable, Steps 6, 7 and 10 will not be executed.
Step 6, the SMF sends an event subscription message to the AMF for requesting to subscribe to a satellite mobility event, if the SMF is unable to determine whether the designated ground station is reachable. The specific implementation is the same as Step 7 in Embodiment 2. The event subscription message includes the information of the designated ground station.
Steps 7-15: these steps are the same as Steps 7-8 and 10-16 in Embodiment 2.

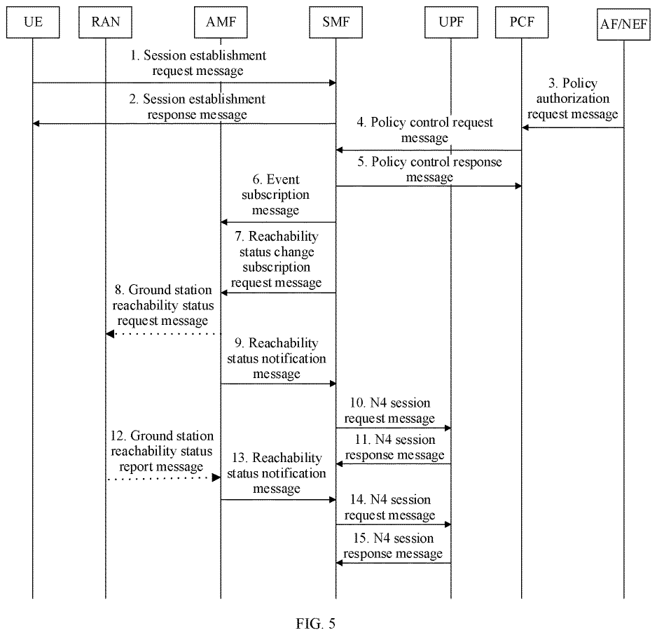

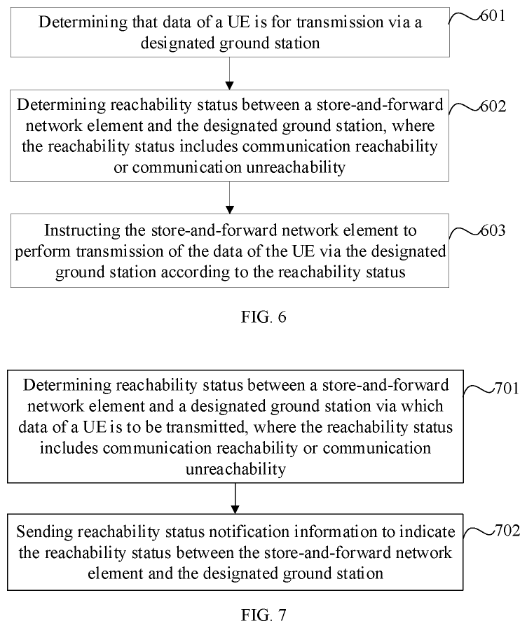

According to the same inventive concept, the present disclosure also provides a data forwarding method applied to a first control network element. As shown in FIG. 6, the method includes:
Step 601, determining that data of a UE is for transmission via a designated ground station;
Step 602, determining reachability status between a store-and-forward network element and the designated ground station, where the reachability status includes communication reachability or communication unreachability;
Step 603, instructing the store-and-forward network element to perform transmission of the data of the UE via the designated ground station according to the reachability status.

In some possible embodiments, the instructing the store-and-forward network element to perform transmission of the data of the UE via the designated ground station according to the reachability status includes:
when the reachability status is the communication unreachability, instructing the store-and-forward network element to store uplink data of the UE upon reception of the uplink data of the UE, and/or instructing the store-and-forward network element to discard downlink data of the UE upon reception of the downlink data of the UE transmitted by a non-designated ground station; or,
when the reachability status is the communication reachability, instructing the store-and-forward network element to forward uplink data of the UE to the designated ground station upon determination that the uplink data of the UE has been stored, and/or instructing the store-and-forward network element to store downlink data of the UE upon reception of the downlink data of the UE transmitted by the designated ground station.

In some possible embodiments, the determination that the data of the UE is for transmission via the designated ground station is based on at least one of following information:
subscription data information of the UE;
indication information provided by an AF or a second control network element;
local configuration information.

In some possible embodiments, the determination of the reachability status between the store-and-forward network element and the designated ground station is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

In some possible embodiments, the method further includes:
receiving the reachability status notification information of the designated ground station based on a subscription or request for the reachability status notification information.

In some possible embodiments, the reachability status notification information includes at least one of the following:
indication information indicating a change in the reachability status;
predicted time information for a change in future reachability status;
information of the designated ground station.

In some possible embodiments, the data of the UE includes uplink data, and the uplink data includes all uplink data of the UE or a portion of session-level uplink data of the UE; and/or
the data of the UE includes downlink data, and the downlink data includes all downlink data of the UE or a portion of session-level downlink data of the UE.

According to the same inventive concept, the present disclosure also provides a data forwarding method applied to a second control network element. As shown in FIG. 7, the method includes:
Step 701, determining reachability status between a store-and-forward network element and a designated ground station via which data of a UE is to be transmitted, where the reachability status includes communication reachability or communication unreachability;
Step 702, sending reachability status notification information to indicate the reachability status between the store-and-forward network element and the designated ground station.

In some possible embodiments, the method further includes:
determining that the data of the UE is for transmission via the designated ground station;
sending to a first control network element indication information that the data of the UE is for transmission via the designated ground station.

In some possible embodiments, the determination that the data of the UE is for transmission via the designated ground station is based on at least one of following information:
subscription data information of the UE;
local configuration information.

In some possible embodiments, the determination of the reachability status between the store-and-forward network element and the designated ground station via which the data of the UE is to be transmitted is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

In some possible embodiments, the sending reachability status notification information, includes:
sending the reachability status notification information according to a subscription or request for the reachability status notification information.

In some possible embodiments, the reachability status notification information includes at least one of the following:
indication information indicating a change in the reachability status;
predicted time information for a change in future reachability status;
information of the designated ground station.

In some possible embodiments, the data of the UE includes uplink data, and the uplink data includes all uplink data of the UE or a portion of session-level uplink data of the UE; and/or
the data of the UE includes downlink data, and the downlink data includes all downlink data of the UE or a portion of session-level downlink data of the UE.

Following the introduction of the data forwarding method according to the exemplary implementations of the present disclosure, a data forwarding device according to another exemplary implementation of the present disclosure is now described.

According to the same concept, the present disclosure provides a data forwarding device serving as a first control network element. The device includes at least one processor, a transceiver and a memory that communicates with the at least one processor. The memory stores an instruction executable by the at least one processor, and the instruction is executed by the at least one processor, so that the at least one processor can perform the data forwarding method executed by the first control network element in the above embodiments.

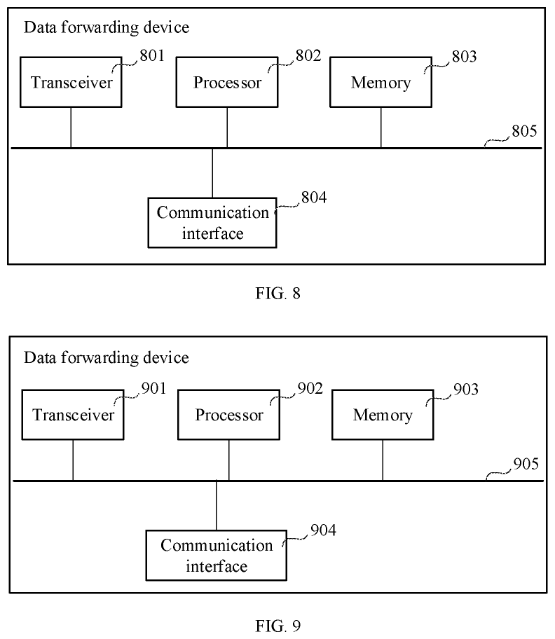

Taking one processor as an example, FIG. 8 is a structural schematic diagram of a data forwarding device serving as a first control network element provided by the present disclosure.

The data forwarding device includes a transceiver 801, a processor 802, a memory 803 and a communication interface 804. Among them, the transceiver 801, the processor 802, the memory 803 and the communication interface 804 are interconnected through a bus 805.

Among them, the memory 803 is used to store a program. Specifically, the program can include program code, and the program code includes computer operation instruction. The memory 803 can be a volatile memory, such as a random-access memory (RAM). The memory 803 can also be a non-volatile memory, such as a flash memory, a hard disk drive (HDD) or a solid-state drive (SSD). The memory 803 can also be a combination of any one or more of the above volatile memory and non-volatile memory.

The memory 803 stores the following elements, executable modules or data structures, or their subsets, or their extended sets:

Operation instruction: including various operation instructions for implementing various operations.

Operating system: including various system programs for implementing various basic businesses and handle hardware-based tasks.

The bus 805 can be a peripheral component interconnect (PCI) bus or an extended industry standard architecture (EISA) bus, etc. The bus can be classified into an address bus, a data bus, a control bus, etc. For ease of representation, only one thick line is used in FIG. 8, but this does not mean there is only one bus or one type of bus.

The processor 802 can be a central processing unit (CPU), a network processor (NP), or a combination of the CPU and the NP. The processor 802 can also be a hardware chip. The above-mentioned hardware chip can be an application-specific integrated circuit (ASIC), a programmable logic device (PLD), or their combinations. The above-mentioned PLD can be a complex programmable logic device (CPLD), a field-programmable gate array (FPGA), a generic array logic (GAL), or any combination thereof.

The transceiver 801 is configure to send and receive data.

The processor 802 is configure to read the program in the memory 803 and perform the steps of the data forwarding method applied to the first control network element as provided in the above embodiments.

According to the same concept, the present disclosure provides a data forwarding device serving as a second control network element that communicates with a first control network element. The device includes at least one processor, a transceiver and a memory that communicates with the at least one processor. The memory stores an instruction executable by the at least one processor, and the instruction is executed by the at least one processor, so that the at least one processor can perform the data forwarding method executed by the second control network element communicating with the first control network element in the above embodiments.

Taking one processor as an example, FIG. 9 is a structural schematic diagram of a data forwarding device serving as a second control network element provided by the present disclosure.

The data forwarding device includes a transceiver 901, a processor 902, a memory 903 and a communication interface 904. Among them, the transceiver 901, the processor 902, the memory 903 and the communication interface 904 are interconnected through a bus 905.

Among them, the memory 903 is used to store a program. Specifically, the program can include program code, and the program code includes computer operation instruction. The memory 903 can be a volatile memory, such as a random-access memory (RAM). The memory 903 can also be a non-volatile memory, such as a flash memory, a hard disk drive (HDD) or a solid-state drive (SSD). The memory 903 can also be a combination of any one or more of the above volatile memory and non-volatile memory.

The memory 903 stores the following elements, executable modules or data structures, or their subsets, or their extended sets:

Operation instruction: including various operation instructions for implementing various operations.

Operating system: including various system programs for implementing various basic businesses and handle hardware-based tasks.

The bus 905 can be a peripheral component interconnect (PCI) bus or an extended industry standard architecture (EISA) bus, etc. The bus can be classified into an address bus, a data bus, a control bus, etc. For ease of representation, only one thick line is used in FIG. 9, but this does not mean there is only one bus or one type of bus.

The processor 902 can be a central processing unit (CPU), a network processor (NP), or a combination of the CPU and the NP. The processor 902 can also be a hardware chip. The above-mentioned hardware chip can be an application-specific integrated circuit (ASIC), a programmable logic device (PLD), or their combinations. The above-mentioned PLD can be a complex programmable logic device (CPLD), a field-programmable gate array (FPGA), a generic array logic (GAL), or any combination thereof.

The transceiver 901 is configure to send and receive data.

The processor 902 is configure to read the program in the memory 903 and perform the steps of the data forwarding method applied to the second control network element as provided in the above embodiments.

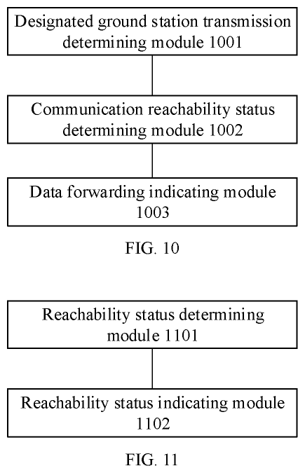

According to the same inventive concept, an embodiment of the present disclosure provides a data forwarding apparatus. The apparatus serves as the first control network element and, as shown in FIG. 10, includes:
a designated ground station transmission determining module 1001, configure to determine that data of a UE is for transmission via a designated ground station;
a communication reachability status determining module 1002, configure to determine reachability status between a store-and-forward network element and the designated ground station, where the reachability status includes communication reachability or communication unreachability;
a data forwarding indicating module 1003, configure to instruct the store-and-forward network element to perform transmission of the data of the UE via the designated ground station according to the reachability status.

According to the same inventive concept, an embodiment of the present disclosure provides a data forwarding apparatus. The apparatus serves as a second control network element communicating with a first control network element and, as shown in FIG. 11, includes:
a reachability status determining module 1101, configure to determine reachability status between a store-and-forward network element and a designated ground station via which data of a UE is to be transmitted, where the reachability status includes communication reachability or communication unreachability;
a reachability status indicating module 1102, configure to send reachability status notification information to indicate the reachability status between the store-and-forward network element and the designated ground station.

In some possible implementations, various aspects of the data forwarding method provided by the present disclosure can also be implemented in a form of a program product, which includes program code. When the program product runs on a computer device, the program code is used to cause the computer device to perform the steps in the data forwarding methods described above according to various exemplary implementations of the present disclosure.

The program product can adopt any combination of one or more readable media. The readable media can be a readable signal medium or a readable storage medium. For example, the readable storage medium can be, but not limited to an electrical, magnetic, optical, electromagnetic, infrared, or a semiconductor system, device or component, or any combination of the above. More specific examples of the readable storage medium (non-exhaustive lists) include: an electrical connection with one or more wires, a portable disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above.

Obviously, those skilled in the art can make various modifications and variations to the present disclosure without departing from the spirit and scope thereof. Thus, if these modifications and variations of the present disclosure fall within the scope of the claims of the present disclosure and their equivalent technology, the present disclosure also intends to include these modifications and variations.

What is claimed is:

1. A data forwarding method, applied to a first control network element, the method comprising:
determining that data of a user equipment (UE) is for transmission via a designated ground station;
determining reachability status between a store-and-forward network element and the designated ground station, wherein the reachability status comprises communication reachability or communication unreachability;
instructing the store-and-forward network element to perform transmission of the data of the UE via the designated ground station according to the reachability status.

2. The method according to claim 1, wherein the instructing the store-and-forward network element to perform transmission of the data of the UE via the designated ground station according to the reachability status comprises:
when the reachability status is the communication unreachability, instructing the store-and-forward network element to store uplink data of the UE upon reception of the uplink data of the UE, and/or instructing the store-and-forward network element to discard downlink data of the UE upon reception of the downlink data of the UE transmitted by a non-designated ground station.

3. The method according to claim 1, wherein the instructing the store-and-forward network element to perform transmission of the data of the UE via the designated ground station according to the reachability status comprises:
when the reachability status is the communication reachability, instructing the store-and-forward network element to forward uplink data of the UE to the designated ground station upon determination that the uplink data of the UE has been stored, and/or instructing the store-and-forward network element to store downlink data of the UE upon reception of the downlink data of the UE transmitted by the designated ground station.

4. The method according to claim 1, wherein the determination that the data of the UE is for transmission via the designated ground station is based on at least one of following information:
subscription data information of the UE;
indication information provided by an application function (AF) or a second control network element;
local configuration information.

5. The method according to claim 1, wherein the determination of the reachability status between the store-and-forward network element and the designated ground station is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

6. The method according to claim 5, further comprising:
receiving the reachability status notification information of the designated ground station based on a subscription or request for the reachability status notification information.

7. The method according to claim 5, wherein the reachability status notification information comprises at least one of the following:
indication information indicating a change in the reachability status;
predicted time information for a change in future reachability status;
information of the designated ground station.

8. The method according to claim 1, wherein,
the data of the UE comprises uplink data, and the uplink data comprises all uplink data of the UE or a portion of session-level uplink data of the UE; and/or
the data of the UE comprises downlink data, and the downlink data comprises all downlink data of the UE or a portion of session-level downlink data of the UE.

9. A data forwarding method, applied to a second control network element and comprising:
determining reachability status between a store-and-forward network element and a designated ground station via which data of a user equipment (UE) is to be transmitted, wherein the reachability status comprises communication reachability or communication unreachability;
sending reachability status notification information to indicate the reachability status between the store-and-forward network element and the designated ground station.

10. The method according to claim 9, further comprising:
determining that the data of the UE is for transmission via the designated ground station;
sending to a first control network element indication information that the data of the UE is for transmission via the designated ground station.

11. The method according to claim 10, wherein the determination that the data of the UE is for transmission via the designated ground station is based on at least one of following information:
subscription data information of the UE;
local configuration information.

12. The method according to claim 9, wherein the determination of the reachability status between the store-and-forward network element and the designated ground station via which the data of the UE is to be transmitted is based on at least one of following information:
received reachability status notification information of the designated ground station;
at least one of local ephemeris data, information of a satellite hosting the store-and-forward network element, information of the designated ground station, or connection status between the store-and-forward network element and the designated ground station.

13. The method according to claim 9, wherein the sending reachability status notification information comprises:
sending the reachability status notification information according to a subscription or request for the reachability status notification information.

14. The method according to claim 9, wherein the reachability status notification information comprises at least one of the following:
indication information indicating a change in the reachability status;
predicted time information for a change in future reachability status;
information of the designated ground station.

15. The method according to claim 9, wherein
the data of the UE comprises uplink data, and the uplink data comprises all uplink data of the UE or a portion of session-level uplink data of the UE; and/or
the data of the UE comprises downlink data, and the downlink data comprises all downlink data of the UE or a portion of session-level downlink data of the UE.

16. A data forwarding device, wherein the data forwarding device serves as a first control network element and comprises at least one processor, and a memory that communicates with the at least one processor; wherein the memory stores an instruction executable by the at least one processor, and the at least one processor executes the instruction to:
determine that data of a user equipment (UE) is for transmission via a designated ground station;
determine reachability status between a store-and-forward network element and the designated ground station, wherein the reachability status comprises communication reachability or communication unreachability;
instruct the store-and-forward network element to perform transmission of the data of the UE via the designated ground station according to the reachability status.

17. The data forwarding device according to claim 16, wherein the at least one processor executes the instruction to:
when the reachability status is the communication unreachability, instruct the store-and-forward network element to store uplink data of the UE upon reception of the uplink data of the UE, and/or instruct the store-and-forward network element to discard downlink data of the UE upon reception of the downlink data of the UE transmitted by a non-designated ground station; or,
when the reachability status is the communication reachability, instruct the store-and-forward network element to forward uplink data of the UE to the designated ground station upon determination that the uplink data of the UE has been stored, and/or instruct the store-and-forward network element to store downlink data of the UE upon reception of the downlink data of the UE transmitted by the designated ground station.

18. A data forwarding device, wherein the data forwarding device serves as a second control network element and comprises at least one processor, and a memory that communicates with the at least one processor; the memory stores an instruction executable by the at least one processor, and the at least one processor executes the instruction to implement the data forwarding method according to claim 9.

19. A non-transitory storage medium storing a computer program, wherein the computer program enables a computer to implement the data forwarding method according to claim 1.

20. A non-transitory storage medium storing a computer program, wherein the computer program enables a computer to implement the data forwarding method according to claim 9.
